(19) United States
(12) Patent Application Publication
(10) Pub. No.: US 2026/0066493 A1
(43) Pub. Date: Mar. 5, 2026

(54) ELECTRODE ASSEMBLY AND RECHARGEABLE BATTERY INCLUDING THE SAME

(71) Applicant: SAMSUNG SDI CO., LTD., Yongin-si (KR)

(72) Inventors: Eunjeong MOON, Yongin-si (KR); Donghyun KIM, Yongin-si (KR); Yejin SEO, Yongin-si (KR)

(21) Appl. No.: 19/231,995

(22) Filed: Jun. 9, 2025

(30) Foreign Application Priority Data
Sep. 4, 2024 (KR) 10-2024-0120377

(51) Int. Cl. H01M 50/536; H01M 50/105; H01M 50/119; H01M 50/121; H01M 50/126; H01M 50/538

(52) U.S. Cl. CPC H01M 50/536; H01M 50/105; H01M 50/119; H01M 50/121; H01M 50/126; H01M 50/538

(57) ABSTRACT

An electrode assembly and a rechargeable battery (e.g., a lithium-ion rechargeable battery) including the electrode assembly are disclosed. The electrode assembly may include: a separator; and a first electrode and a second electrode that are disposed or provided with the separator provided between the first electrode and the second electrode; a plurality of first electrode tabs that extends from the first electrode and is integrally fixed by a first welding portion; and a first lead tab fixed to the plurality of first electrode tabs by a second welding portion, wherein the first welding portion and the second welding portion do not overlap.

### CROSS-REFERENCE TO RELATED APPLICATION

The present application claims priority to and the benefit of Korean Patent Application No. 10-2024-0120377, filed on Sep. 4, 2024, in the Korean Intellectual Property Office, the entire disclosure of which is incorporated herein by reference.

### BACKGROUND

### 1. Field

One or more embodiments of the present disclosure relate to a rechargeable battery (e.g., a lithium-ion rechargeable battery), and, for example, to an electrode assembly and a rechargeable battery (e.g., a lithium-ion rechargeable battery) including the electrode assembly.

### 2. Description of the Related Art

As the demand for portable electronic products, such as laptops, video cameras, and/or mobile phones, increases rapidly and robots and electric vehicles become commercially available, research on rechargeable batteries capable of being repeatedly charged and discharged is actively being conducted.

The secondary batteries include an electrode assembly and a case to accommodate the electrode assembly and may be classified into a cylindrical battery, a prismatic battery, and a pouch-type or kind battery depending on their appearance.

The electrode assembly includes a positive electrode, a negative electrode, a separator, electrode tabs that extend from the positive electrode and the negative electrode, and lead tabs fixed to the electrode tabs.

In the process of fixing the electrode tabs and the lead tabs, the electrode tabs and the lead tabs are fixed integrally, and then the electrode tabs and the lead tabs are fixed, and at this time, two welding operations are performed. During these two welding operations, defects may occur in the electrode tabs and/or the lead tabs.

The foregoing information disclosed in this background section is only for enhancement of understanding of the background of the present disclosure, and therefore, it may contain information that does not form the related art that is already known to a person of ordinary skill in the art.

### SUMMARY

One or more aspects of embodiments of the present disclosure are directed toward an electrode assembly that may prevent defects, such as cracks, from occurring at a portion where a plurality of electrode tabs are fixed (or reduce a degree to or occurrence of which defects, such as cracks, occur at a portion where a plurality of electrode tabs are fixed) and a rechargeable battery (e.g., a lithium-ion rechargeable battery) including the electrode assembly.

However, the technical problem to be solved by the present disclosure is not limited to the above, and other objects not mentioned herein will be understood from the following description by those skilled in the art.

Additional aspects of embodiments will be set forth in part in the description which follows and, in part, will be apparent from the description or may be learned by practice of the presented embodiments of the disclosure.

One or more embodiments of the present disclosure provide an electrode assembly including: a separator; and a first electrode and a second electrode that are disposed or provided with the separator interposed or provided therebetween (e.g., between the first electrode and the second electrode); a plurality of first electrode tabs that extends from the first electrode and is integrally fixed by a first welding portion; and a first lead tab fixed to the plurality of first electrode tabs by a second welding portion, wherein the first welding portion and the second welding portion do not overlap.

The first welding portion may be disposed or provided in a first welding area in which the plurality of first electrode tabs and the first lead tab do not overlap, the second welding portion may be disposed or provided in a second welding area in which the plurality of first electrode tabs and the first lead tab overlap, and the first welding area may be disposed or provided on both sides (e.g., two opposing sides) of the second welding area.

The plurality of first electrode tabs may further include a non-welded area.

The non-welded area may be disposed or provided between the first welding area and the second welding area.

The electrode assembly may further include a plurality of second electrode tabs that extends from the second electrode and is integrally fixed by a third welding portion, and a second lead tab fixed to the plurality of second electrode tabs by a fourth welding portion, wherein the third welding portion and the fourth welding portion may not overlap.

The third welding portion may be disposed or provided in a third welding area in which the plurality of second electrode tabs and the second lead tab do not overlap, the fourth welding portion may be disposed or provided in a fourth welding area in which the plurality of second electrode tabs and the second lead tab overlap, and the third welding area may be disposed or provided on both sides (e.g., two opposing sides) of the fourth welding area.

The plurality of second electrode tabs may further include a non-welded area (e.g., an other non-welded area).

The non-welded area (e.g., the other non-welded area) may be disposed or provided between the third welding area and the fourth welding area.

The first welding portion may be performed by ultrasonic welding, and the second welding portion may be performed by ultrasonic welding and/or laser welding.

The third welding portion may be performed by ultrasonic welding, and the fourth welding portion may be performed by ultrasonic welding and/or laser welding.

One or more embodiments of the present disclosure provide a rechargeable battery (e.g., a lithium-ion rechargeable battery) including the electrode assembly as described in one or more embodiments and a case that accommodates the electrode assembly.

The case may be configured or provided to have a pouch-type or kind shape.

The case may include an upper sheet and a lower sheet.

The upper sheet may include an accommodation portion that accommodates the electrode assembly and a sealing portion around (e.g., surrounding) the accommodation portion.

Each of the upper sheet and the lower sheet may include a metal sheet and a polymer sheet that covers an inner surface and an outer surface of the metal sheet.

According to one or more embodiments of the present disclosure, because the first welding portion to fix integrally the plurality of electrode tabs and the second welding portion to fix the plurality of electrode tabs and the lead tab do not overlap, it may be feasible to prevent defects, such as cracks, from occurring (or reduce a degree to or occurrence of which defects, such as cracks, occur) at the portion where the lead tab and the plurality of electrode tabs are fixed.

### BRIEF DESCRIPTION OF THE DRAWINGS

The accompanying drawings are included to provide a further understanding of embodiments of the subject matter of the present disclosure and are incorporated in and constitute a part of this specification. The drawings illustrate embodiments of the subject matter of the present disclosure and, together with the description, serve to explain principles of embodiments of the subject matter of the present disclosure.

FIG. 1 is a schematic perspective view of a rechargeable battery (e.g., a lithium-ion rechargeable battery) according to one or more embodiments of the present disclosure.

FIG. 2 is a schematic perspective view of an electrode assembly according to one or more embodiments of the present disclosure.

FIG. 3 is a schematic enlarged view of area A as illustrated in FIG. 2.

FIG. 4 is a schematic enlarged view of area B as illustrated in FIG. 2.

FIG. 5 is a schematic enlarged view of area C as illustrated in FIG. 2.

FIG. 6 schematically illustrates a state in which a first welding portion is performed according to one or more embodiments of the present disclosure.

FIG. 7 schematically illustrates a state in which a second welding portion is performed according to one or more embodiments of the present disclosure.

FIGS. 8-10 are photographs illustrating whether there are any defects after integrally fixing a plurality of electrode tabs with a first welding portion and fixing a lead tab and the plurality of electrode tabs with a second welding portion.

### DETAILED DESCRIPTION

The subject matter of the present disclosure will be described more fully hereinafter with reference to the accompanying drawings, in which one or more embodiments of the present disclosure are shown. As those skilled in the art would realize, the described embodiments may be modified in one or more suitable different ways, all without departing from the spirit or scope of the present disclosure.

In order to clearly describe the present disclosure, parts or portions that are irrelevant to the description may not be provided, and substantially identical or similar constituent elements throughout the present disclosure may be denoted by the same reference numerals.

Further, in the drawings, the size and thickness of each element may be arbitrarily illustrated for ease of description, and embodiments of the present disclosure are not necessarily limited to those illustrated in the drawings. In the drawings, the thicknesses of layers, films, panels, regions, areas, and/or the like may be exaggerated for clarity. In the drawings, for ease of description, the thicknesses of one or more layers and areas may be exaggerated.

The term “and/or” shall include the combination of a plurality of listed items or any of the plurality of listed items.

The terms, such as “below,” “lower,” “above,” “upper,” and/or the like, are used herein for ease of description to describe one element's relation to another element(s) as illustrated in the drawings. These terms are relative concepts and are described based on the directions indicated in the drawings.

It should be understood that if (e.g., when) an element, such as a layer, a film, a region, an area, or a substrate, is referred to as being “on” another element, it may be directly on the other element or intervening elements may also be present therebetween. In contrast, if (e.g., when) an element is referred to as being “directly on” another element, there are no intervening elements present therebetween. Further, in the present disclosure, the word “on” or “above” refers to being disposed or provided on or below the object portion, and does not necessarily refer to being disposed or provided on the upper side of the object portion based on a gravitational direction.

Unless explicitly described to the contrary, the word “has,” “having,” “include,” or “including” will be understood to imply the inclusion of stated elements but not the exclusion of any other elements. For example, it should be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Also, the terms “comprise(s)/comprising,” “include(s)/including,” “have/has/having,” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

The terms, such as “first,” “second,” and/or the like, may be used to describe one or more elements, but these elements shall not be restricted to these terms. These terms may be used to distinguish one element from the other. For instance, the first element may be termed the second element, and vice versa, without departing from the spirit and scope of the present disclosure. Unless clearly indicated otherwise, any expressions in a singular form may include a plural form.

Further, throughout the present disclosure, the phrase “in a plan view” or “on a plane” refers to viewing a target portion from the top, and the phrase “in a cross-sectional view” or “on a cross-section” refers to viewing a cross-section formed by vertically cutting a target portion from the side.

In the drawings, as symbols X, Y, and Z used to indicate directions, ‘X’ is a first direction, ‘Y’ is a second direction normal (e.g., substantially perpendicular) to the first direction, and ‘Z’ is a third direction normal (e.g., substantially perpendicular) to the first direction and the second direction. The first direction X may correspond to the horizontal direction or the left-right direction of the rechargeable battery or the electrode assembly. The second direction Y may correspond to the vertical direction or the length direction of the rechargeable battery or the electrode assembly. The third direction Z may correspond to the thickness direction, the height direction, or the up-down direction of the rechargeable battery or the electrode assembly.

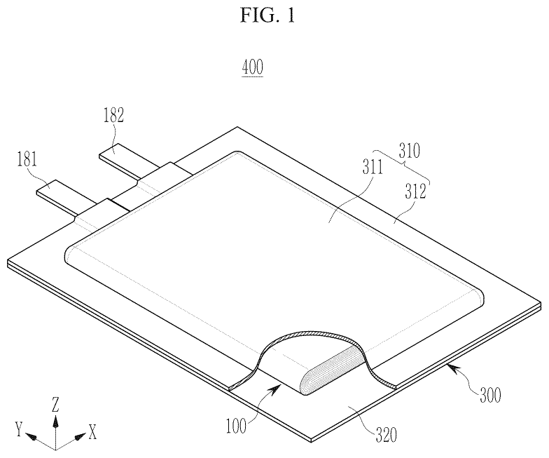

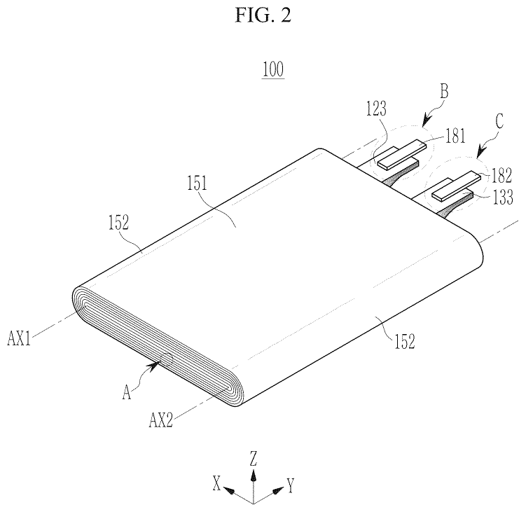

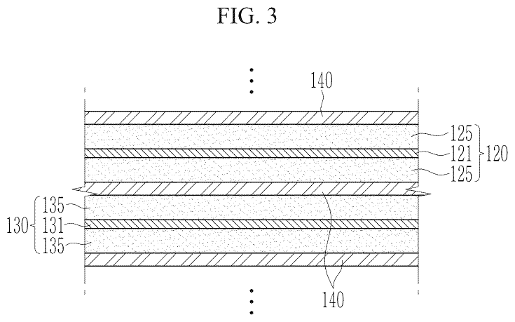

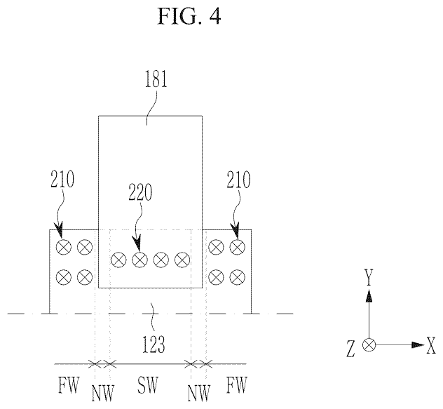

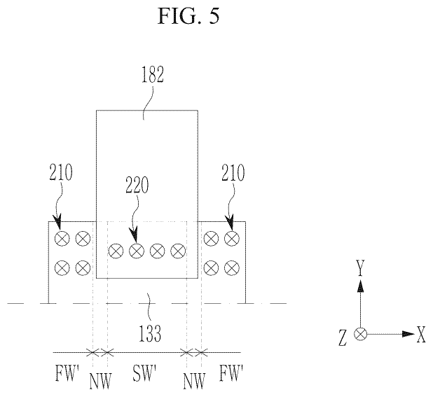

FIG. 1 is a schematic perspective view of a rechargeable battery (e.g., a lithium-ion rechargeable battery) according to one or more embodiments of the present disclosure, FIG. 2 is a schematic perspective view of an electrode assembly according to one or more embodiments of the present disclosure, FIG. 3 is a schematic enlarged view of area A as illustrated in FIG. 2, FIG. 4 is a schematic enlarged view of area B as illustrated in FIG. 2, and FIG. 5 is a schematic enlarged view of area C as illustrated in FIG. 2.

Referring to FIG. 1 to FIG. 5, a rechargeable battery 400 according to one or more embodiments of the present disclosure may include an electrode assembly 100 and a case 300. The case 300 may be in the form of a pouch that accommodates and seals the electrode assembly 100 together with an electrolyte.

The electrode assembly 100 may include a first electrode 120, a second electrode 130, and a separator 140. The separator 140 may be disposed or provided between the first electrode 120 and the second electrode 130 to insulate (e.g., electrically insulate) them. Each of the first electrode 120, the second electrode 130, and the separator 140 may be configured or provided in a long strip shape and may be wound around two winding axes AX1 and AX2 to implement the shape of a flat jelly roll. However, embodiments of the present disclosure are not limited thereto, and the electrode assembly 100 may be formed in a stacked type or kind in which the first electrode plate, the second electrode plate, and the separator are stacked with respect to each other.

The first electrode 120, the separator 140, the second electrode 130, and the separator 140 may be sequentially stacked to form or provide a laminate, and the laminate may be wound around the first winding axis AX1 and the second winding axis AX2 which are disposed or provided at a distance from each other. For example, the laminate may be wound sequentially and alternately around the first winding axis AX1 and the second winding axis AX2.

The electrode assembly 100 may include a central portion 151 of a flat quadrangular shape (e.g., a substantially flat quadrangular shape), and a pair of round portions 152 disposed or provided on both sides (e.g., two opposing sides) of the central portion 151. The central portion 151 may be a flat (e.g., substantially flat) portion of a certain (e.g., set or predetermined) thickness disposed or provided between the first winding axis AX1 and the second winding axis AX2, and the pair of round portions 152 may be semicircular curved portions around (e.g., surrounding) the two winding axes AX1 and AX2, respectively.

The first electrode 120 may include a first substrate 121 and a first combined layer 125 disposed or provided on the first substrate 121. The second electrode 130 may include a second substrate 131 and a second combined layer 135 disposed or provided on the second substrate 131.

In a lithium-ion rechargeable battery, the first substrate 121 may be configured or provided of the first foil, and the first combined layer 125 may include a transition metal oxide, such as LiCoO₂, LiNiO₂, LiMn₂O₄, Li(NiCoAl)O₂, LiFePO₄, and/or Li(NiCoMn)O₂, a conductive (e.g., electrically conductive) material, a binder, and/or the like. The second substrate 131 may be configured or provided of a copper foil and/or a nickel foil, and the second combined layer 135 may include graphite, a conductive (e.g., electrically conductive) material, and a binder. The first electrode 120 may be referred to as a positive electrode, and the second electrode 130 may be referred to as a negative electrode.

The separator 140 may include a polymer material, such as polyethylene and/or polypropylene, and may insulate (e.g., electrically insulate) the first electrode 120 and the second electrode 130 while allowing movement or flowing of lithium ions.

In one or more embodiments, the electrode assembly 100 may further include a plurality of first electrode tabs 123 that extends in the second direction (Y direction) from the first electrode 120 and a plurality of second electrode tabs 133 that extends in the second direction (Y direction) from the second electrode 130. In one or more embodiments, the electrode assembly 100 may further include a first lead tab 181 fixed to the plurality of first electrode tabs 123 and a second lead tab 182 fixed to the plurality of second electrode tabs 133.

The plurality of first electrode tabs 123 may extend from the first substrate 121 and may be integrally fixed by the first welding portion 210, and the first lead tab 181 may be fixed to the plurality of first electrode tabs 123 by the second welding portion 220. The first welding portion 210 may be disposed or provided in the first welding area FW, and the second welding portion 220 may be disposed or provided in the second welding area SW. The first welding portion 210 may be performed by ultrasonic welding, and the second welding portion 220 may be performed by ultrasonic welding and/or laser welding.

The plurality of second electrode tabs 133 may extend from the second substrate 131 and may be integrally fixed by the third welding portion 230, and the second lead tab 182 may be fixed to the plurality of second electrode tabs 133 by the fourth welding portion 240. The third welding portion 230 may be disposed or provided in the third welding area FW′, and the fourth welding portion 240 may be disposed or provided in the fourth welding area SW′. The third welding portion 230 may be performed by ultrasonic welding, and the fourth welding section 240 may be performed by ultrasonic welding and/or laser welding.

The first welding area FW may be disposed or provided on the plurality of first electrode tabs 123, and the second welding area SW may be disposed or provided on the plurality of first electrode tabs 123 and the first lead tab 181. For example, the plurality of first electrode tabs 123 and the first lead tab 181 may not overlap in the first welding area FW, and the plurality of first electrode tabs 123 and the first lead tab 181 may overlap in the second welding area SW. The first welding area FW may be disposed or provided on both sides (e.g., two opposing sides) of the second welding area SW. Herein, the first welding area FW and the second welding area SW may not overlap. For example, the first welding portion 210 and the second welding portion 220 may not overlap.

The third welding area FW′ may be disposed or provided on the plurality of second electrode tabs 133, and the fourth welding area SW′ may be disposed or provided on the plurality of second electrode tabs 133 and the second lead tab 182. For example, the plurality of second electrode tabs 133 and the second lead tab 182 may not overlap in the third welding area FW′, and the plurality of second electrode tabs 133 and the second lead tab 182 may overlap in the fourth welding area SW′. The third welding area FW′ may be disposed or provided on both sides (e.g., two opposing sides) of the fourth welding area SW′. Herein, the third welding area FW′ and the fourth welding area SW′ may not overlap. For example, the third welding portion 230 and the fourth welding portion 240 may not overlap.

As described in one or more embodiments, as the first welding portion 210 and the second welding portion 220 do not overlap and the third welding portion 230 and the fourth welding portion 240 do not overlap, defects, such as cracks, may be prevented from occurring (or a degree to or occurrence of which defects, such as cracks, occur may be reduced) in a portion where the plurality of first electrode tabs 123 and the first lead tab 181 are fixed and in a portion where the plurality of second electrode tabs 133 and the second lead tab 182 are fixed.

In one or more embodiments, the plurality of first electrode tabs 123 and the plurality of second electrode tabs 133 may further include a non-welded area NW that is not welded. The non-welded area NW may be disposed or provided between the first welding area FW and the second welding area SW and between the third welding area FW′ and the fourth welding area SW′. For example, the first welding portion 210 and the third welding portion 230 may not be continuously (e.g., substantially continuously) disposed or provided throughout the plurality of first electrode tabs 123 and the plurality of second electrode tabs 133, respectively.

The case 300 may include an upper sheet 310 and a lower sheet 320. The upper sheet 310 may include an accommodation portion 311 and a sealing portion 312 around (e.g., surrounding) the accommodation portion 311. The accommodation portion 311 may be formed or provided of a set or predetermined space provided on the upper sheet 310 to accommodate the electrode assembly 100. If (e.g., when) the upper side and the lower side of the secondary battery 400 are reversed, the upper sheet 310 and the lower sheet 320 may be referred to as the lower sheet and the upper sheet, respectively.

Each of the upper sheet 310 and the lower sheet 320 may include a metal sheet and a plurality of polymer sheets that covers the inner surface and the outer surface of the metal sheet. The metal sheet may be an aluminum sheet, which increases the mechanical strength of the case 300. The polymer sheet may include at least one selected from among a polyethylene terephthalate (PET) sheet, a nylon sheet, and a PET-nylon composite sheet and provide insulation (e.g., electrical insulation) and protection to the case 300.

The first lead tab 181 and the second lead tab 182 may partially overlap the sealing portion 312, and end portions of the first lead tab 181 and the second lead tab 182 may be exposed to the outside of the sealing portion 312. A protective tape may be attached to a portion of the first lead tab 181 and the second lead tab 182 that overlaps the sealing portion 312. After the electrode assembly 100 and the electrolyte are accommodated in the accommodation portion 311, the sealing portion 312 of the upper sheet 310 and the edge of the lower sheet 320 may be integrally bonded by thermal fusion.

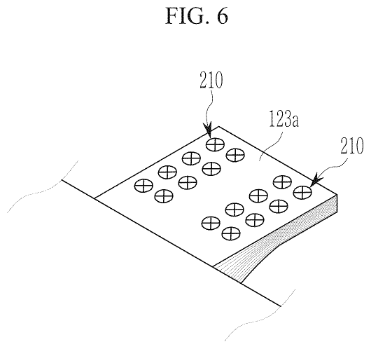

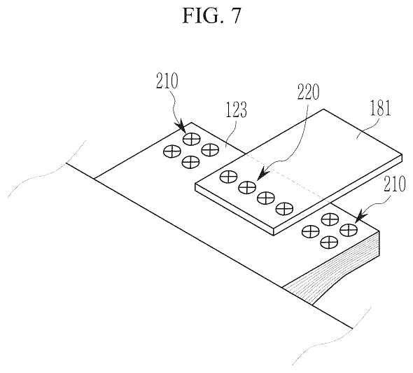

Hereinafter, the first welding portion and the second welding portion will be described in more detail with reference to FIG. 6 and FIG. 7.

FIG. 6 schematically illustrates a state in which a first welding portion is performed according to one or more embodiments of the present disclosure, and FIG. 7 schematically illustrates a state in which a second welding portion is performed according to one or more embodiments of the present disclosure.

In FIG. 6 and FIG. 7, a plurality of first electrode tabs 123, a first lead tab 181, a first welding portion 210, and a second welding portion 220 will be described in more detail, but substantially the same may be applied to a plurality of second electrode tabs 133, a second lead tab 182, a third welding portion 230, and a fourth welding portion 240.

Referring to FIG. 6, a plurality of first electrode tab substrates 123a may be integrally fixed by the first welding portion 210. The plurality of first electrode tab substrates 123a may extend from the first substrate 121. The first welding portion 210 may be performed by ultrasonic welding on both side portions (e.g., two opposing side portions) of the plurality of first electrode tab substrates 123a. For example, the first welding portion 210 may not be continuously (e.g., substantially continuously) disposed or provided on the plurality of first electrode tab substrates 123a, but may be disposed or provided on both sides (e.g., two opposing sides) of the plurality of first electrode tab substrates 123a.

Referring to FIG. 7, after the end portions of the plurality of first electrode tab substrates 123a are partially cut to form or provide a plurality of first electrode tabs 123, the first lead tab 181 and the plurality of first electrode tabs 123 may be fixed by the second welding portion 220. Herein, after integrally fixing the plurality of first electrode tab substrates 123a with the first welding portion 210, the end portions of the plurality of first electrode tab substrates 123a may be partially cut, so that the length of the plurality of first electrode tabs 123 may be reduced.

The second welding portion 220 may be performed by ultrasonic welding and/or laser welding. The second welding portion 220 may be disposed or provided between the first welding portions 210 and may not overlap the first welding portion 210. Accordingly, defects (or a degree or occurrence of defects), such as cracks, caused by the overlap of the second welding portion 220 and the first welding portion 210 may be prevented.

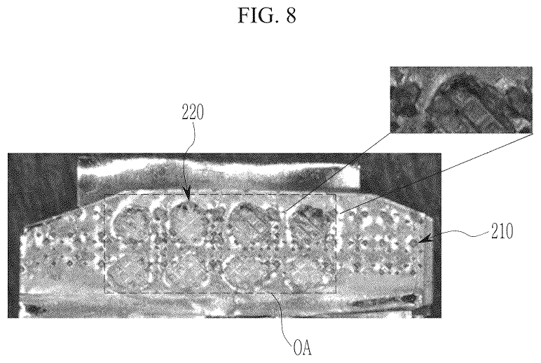

Hereinafter, the aspects and features of the first welding portion and the second welding portion according to one or more embodiments of the present disclosure will be described in more detail with reference to FIG. 8 to FIG. 10.

FIG. 8 to FIG. 10 are photographs illustrating whether there are any defects after integrally fixing a plurality of electrode tabs with the first welding portion 210 and fixing a lead tab and the plurality of electrode tabs with the second welding portion 220.

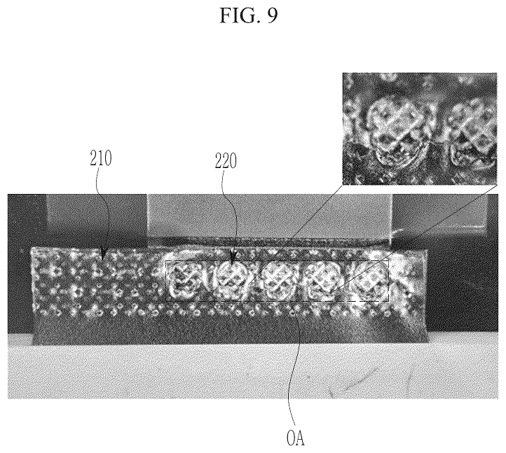

FIG. 8 is a photograph of a comparative example in which the first welding portion 210 is disposed or provided throughout the plurality of electrode tabs. Accordingly, in the case of the comparative example according to FIG. 8, the first welding portion 210 and the second welding portion 220 overlap. FIG. 9 is a photograph of a comparative example in which the first welding portion 210 is disposed or provided in a concave portion (W) shape. Accordingly, in the case of the comparative example according to FIG. 9, the first welding portion 210 and the second welding portion 220 partially overlap.

Referring to FIG. 8 and FIG. 9, it can be seen that cracks occur in a portion OA where the first welding portion 210 and the second welding portion 220 overlap, for example, a portion where the lead tab and the plurality of electrode tabs are fixed.

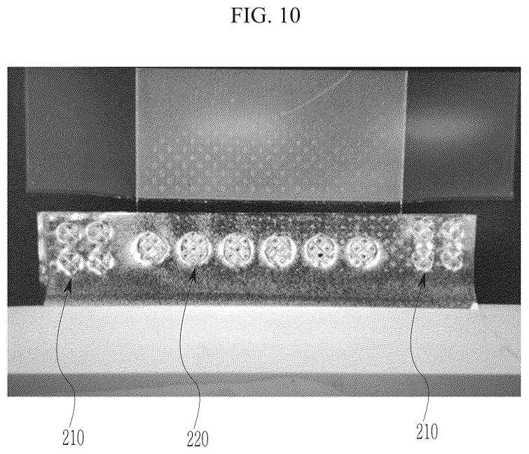

FIG. 10 is a photograph of a case according to one or more embodiments of the present disclosure, in which the first welding portion 210 and the second welding portion 220 do not overlap. Referring to FIG. 10, it may be seen that defects, such as cracks, do not occur in a portion where the lead tab and the plurality of electrode tabs are fixed.

While the subject matter of the present disclosure has been described in connection with what is presently considered to be practical embodiments, it is to be understood that the present disclosure is not limited to the disclosed embodiments, but, in one or more embodiments, is intended to cover one or more suitable modifications and equivalent arrangements included within the spirit and scope of the appended claims and equivalents thereof. It therefore will be understood that one or more embodiments described herein are just illustrative but not limitative in all aspects.

Reference Numerals

| | |
|---|---|
| 100: electrode assembly | 120: first electrode |
| 121: first substrate | 123: first electrode tab |
| 125: first combined layer | 130: second electrode |
| 131: second substrate | 133: second electrode tab |
| 135: second combined layer | 140: separator |
| 151: central portion | 152: round portion |
| 181: first lead tab | 182: second lead tab |
| 210: first welding portion | 220: second welding portion |
| 230: third welding portion | 240: fourth welding portion |
| 300: case | 310: upper sheet |
| 311: accommodation portion | 312: sealing portion |
| 320: lower sheet | 400: rechargeable battery |

What is claimed is:

1. An electrode assembly comprising:
a separator; and
a first electrode and a second electrode that are provided with the separator provided therebetween;
a plurality of first electrode tabs that extends from the first electrode and is integrally fixed by a first welding portion; and
a first lead tab fixed to the plurality of first electrode tabs by a second welding portion,
wherein the first welding portion and the second welding portion do not overlap.

2. The electrode assembly as claimed in claim 1, wherein:
the first welding portion is in a first welding area in which the plurality of first electrode tabs and the first lead tab do not overlap,
the second welding portion is in a second welding area in which the plurality of first electrode tabs and the first lead tab overlap, and
the first welding area is on both sides of the second welding area.

3. The electrode assembly as claimed in claim 2, wherein:
the plurality of first electrode tabs further comprises a non-welded area.

4. The electrode assembly as claimed in claim 3, wherein:
the non-welded area is between the first welding area and the second welding area.

5. The electrode assembly as claimed in claim 1, further comprising:
a plurality of second electrode tabs that extends from the second electrode and is integrally fixed by a third welding portion, and
a second lead tab fixed to the plurality of second electrode tabs by a fourth welding portion,
wherein the third welding portion and the fourth welding portion do not overlap.

6. The electrode assembly as claimed in claim 5, wherein:
the third welding portion is in a third welding area in which the plurality of second electrode tabs and the second lead tab do not overlap,
the fourth welding portion is in a fourth welding area in which the plurality of second electrode tabs and the second lead tab overlap, and
the third welding area is on both sides of the fourth welding area.

7. The electrode assembly as claimed in claim 6, wherein:
the plurality of second electrode tabs further comprises an other non-welded area.

8. The electrode assembly as claimed in claim 7, wherein:
the other non-welded area is between the third welding area and the fourth welding area.

9. The electrode assembly as claimed in claim 1, wherein:
the first welding portion is performed by ultrasonic welding, and
the second welding portion is performed by ultrasonic welding or laser welding.

10. The electrode assembly as claimed in claim 5, wherein:
the third welding portion is performed by ultrasonic welding, and
the fourth welding portion is performed by ultrasonic welding or laser welding.

11. A rechargeable battery comprising:
the electrode assembly as claimed in claim 1; and
a case that accommodates the electrode assembly.

12. The rechargeable battery as claimed in claim 11, wherein:
the case is provided to have a pouch-type shape.

13. The rechargeable battery as claimed in claim 12, wherein:
the case comprises an upper sheet and a lower sheet.

14. The rechargeable battery as claimed in claim 13, wherein:
the upper sheet comprises an accommodation portion that accommodates the electrode assembly and a sealing portion around the accommodation portion.

15. The rechargeable battery as claimed in claim 13, wherein:
each of the upper sheet and the lower sheet comprises a metal sheet and a polymer sheet that covers an inner surface and an outer surface of the metal sheet.
